(19) United States
(12) Patent Application Publication
(10) Pub. No.: US 2007/0272791 A1
(43) Pub. Date: Nov. 29, 2007

(54) CURVED FLANGE ROLLER FOR TAPE GUIDING

(75) Inventors: Daniel W. Underkofler, Lafayette, CO (US); William J. Vanderheyden, Loveland, CO (US)

Correspondence Address: HOGAN & HARTSON LLP, ONE TABOR CENTER, SUITE 1500, 1200 SEVENTEEN ST., DENVER, CO, 80202, US

(73) Assignee: SUN MICROSYSTEMS, INC., Santa Clara, CA (US)

(21) Appl. No.: 11/419,974

(22) Filed: May 23, 2006

(51) Int. Cl. G11B 15/60; B65H 23/038

(52) U.S. Cl. 242/615.2; 242/615.3

(57) ABSTRACT

A flange for a tape roller has a curved shape that substantially solves the problems with skewed tape while maintaining manufacturability. The tape edge makes contact with the tape flange where the slope of the curve shape is substantially flat. From the contact point of the tape and the flange, the flange shape gently curves away. The shape of the flange allows some degree of skew in the tape so that contact with the flange edge is avoided, and yet the distance between the two flanges of the roller is more easily controlled than with a roller having tapered edge flanges.

### BACKGROUND OF THE INVENTION

The present invention is related to tape drives used for data storage and retrieval, and, more particularly, to the shape of the rollers used to guide the tape in the tape drive.

Guiding of tape through a drive and across a read/write head is typically accomplished using a series of rollers having flanges on either end of a roller central portion that is in contact with the tape. The flanges prevent excessive undesirable lateral tape motion (“LTM”). Even though roller flanges are used, non-uniform and intermittent contact of tape edges with the roller flanges can result in fast LTM that the read/write head servo system cannot follow. In addition to axial runout (wobble along the direction of the roller axis) and machining defects, the geometry of the flange itself can result in non-optimum edge-flange contact.

A tape roller 100 with traditional flange geometry 102 is shown in FIG. 1A, with a section view of the tape 106. The tape roller 100 includes a central portion 104 that is in contact with the tape 106. Each flange 102 has a flat underside to provide a surface for contact with the tape edge. While the edge profile of roller flange 102 is shown as being substantially rectangular, in practice at least a small radius is usually present on the outer diameter of flange 102.

Similarly, another tape roller 200 with a more traditional flange geometry 202 is shown in FIG. 2A, with a section view of the tape 206. The tape roller 200 includes a central portion 204 that is in contact with the tape 206 and a radius at the outer diameter of the flange 202. Each flange 202 has a flat underside to provide a surface for contact with the tape edge.

FIGS. 1B and 2B show the tape 106, 206 passing across the central portion of the roller 104, 204. If the tape 106, 206 is skewed in FIGS. 1B and 2B (note the direction of the tape skew in FIGS. 1B and 2B, which produces the undesirable contact between the tape edge and roller flange) as it passes across the roller 100, 200, contact between the tape 106, 206 and roller flange 102, 202 does not occur on the flat edge surface of the flange 102, 202, but at the edges 110 of flange 102, or at the outer diameters 210 of flange 202. This undesirable type of contact can introduce transient LTM and tape edge buckling.

A roller 300 with tapered flanges 302 is shown in FIGS. 3A (tape edge view) and 3B (flat tape view). The problem of contact with a skewed tape as described above is avoided and there is no contact with flange 302 as shown at 310. However, as shown in FIGS. 3A and 3B, there is no flat surface for the tape edge to guide against, which can result in bending of the tape edge. In addition, the space between flanges 302 becomes difficult to control and measure.

The perspectives of FIGS. 4 and 5 serve to further illustrate the problem of tape skew and buckling present in the prior art rollers. FIG. 4 shows the tape 406 passing across the surface 408 of the central portion 404 of the roller 400. Tape 406 is actually skewed in FIG. 4, which produces the undesirable contact 410 between the tape edge and roller flange 402 as it passes across the roller 400. Contact between the tape 406 and roller flange 402 does not occur on the flat edge surface of the flange 402, but at the outer diameter of flange 402. This undesirable type of contact can introduce transient LTM and tape edge stressing as is shown in FIG. 5. In FIG. 5, a portion of roller 500 is shown including flange 502, including an outer cylindrical portion 502A, and an inner slanted portion 502B, as well as a central cylindrical portion 504. The tape 506 can be seen mostly supported by the flat surface of the center portion 504, but an edge portion of the tape 506 is undesirably unsupported and the outermost edge portion is actually undesirably in contact with the surface of the inner slanted portion 502B of flange 502.

Other solutions to the problems described above have been either proposed or built, including a roller with a short flat section of the flange followed by a taper. While all of the proposed solutions have certain benefits, there is still a need for further improvement.

What is desired, therefore, is a roller for a tape drive that avoids the problems with tape skew and buckling, yet is easy to control and manufacture.

### SUMMARY OF THE INVENTION

According to the present invention, a flange for a tape roller has a curved shape that substantially solves the problems of tape skew and manufacturability present in the prior art. The tape edge makes contact with the tape flange where the slope of the curved shape is substantially flat. From the contact point of the tape and the flange, the flange shape gently curves away. The shape of the flange allows some degree of skew in the tape so that contact with the flange edge is avoided, and yet the distance between the two flanges of the roller is more easily controlled than with the prior art tapered flange roller.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1A is a diagram of a tape roller and basic flange according to the prior art, showing a section view of the tape;

FIG. 1B is a diagram of the tape roller shown in FIG. 1A, wherein the tape is seen in a frontal view being pulled across the roller;

FIG. 2A is a diagram of a tape roller and flange having a radius on the flange outer edge according to the prior art, showing a section view of the tape;

FIG. 2B is a diagram of the tape roller shown in FIG. 2B, wherein the tape is seen in a frontal view being pulled across the roller;

FIG. 3A is a diagram of a tape roller and tapered flange according to the prior art, showing a section view of the tape;

FIG. 3B is a diagram of the tape roller shown in FIG. 2B, wherein the tape is seen in a frontal view being pulled across the roller;

FIG. 4 is a diagram of a portion of a tape roller according to the prior art, in which a skewed tape is pulled across the roller, in which the undesirable contact between the skewed tape and the roller flange outer diameter is clearly shown;

FIG. 5 is a diagram of a portion of a tape roller according to the prior art, in which a stressed tape edge is shown to be resting on the inner slanted portion of the roller edge; and

FIG. 6 is a diagram of a portion of a tape roller according to the present invention.

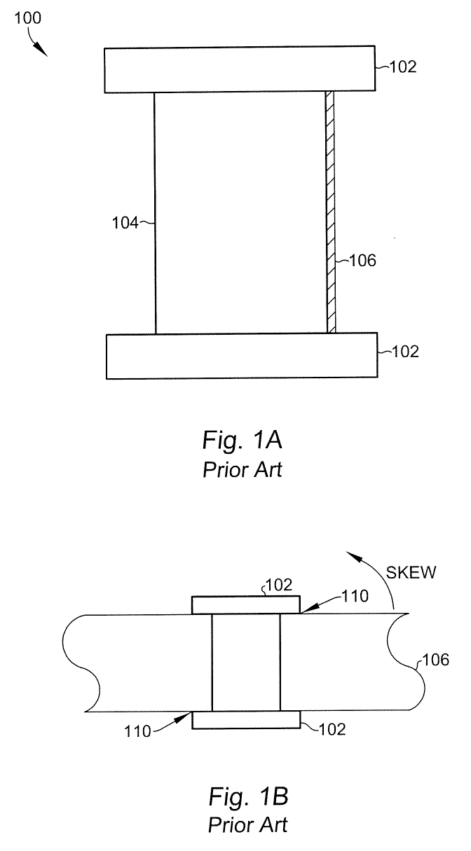

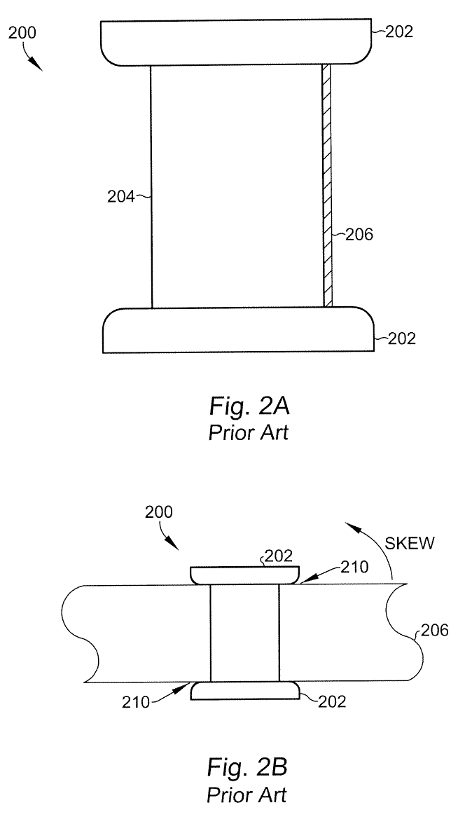

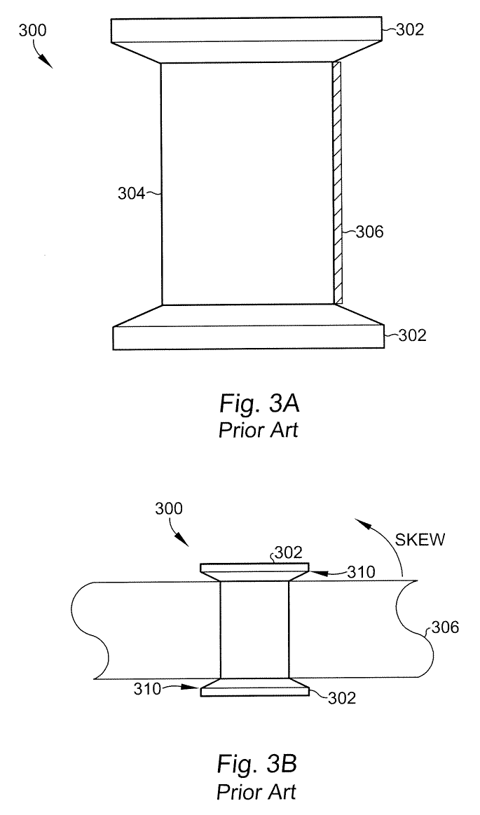

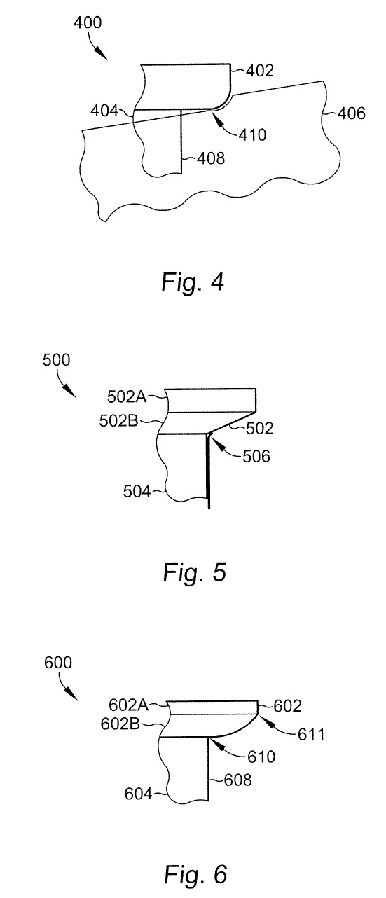

### DETAILED DESCRIPTION

Referring now to FIG. 6, a portion of a tape roller 600 is shown including a flange according to the present invention, and a roller center portion 604, with a roller surface 608 for engaging the tape. The flange 602 has a parabolic or similar shape that avoids the tape skew and manufacturability problems of the prior art tape rollers described above. The tape edge contacts the roller flange 602 at a point 610 along the roller flange curve that has a zero slope. The curve of the flange 602 gently curves away from point 610 towards the edge of the flange. The shape of the roller flange 602 allows some degree of skew in the tape so that contact with an edge 611 of the roller flange is avoided.

Parabolic and circular curve profiles are both good candidates to be used in embodiments of the roller flange of the present invention. The key to the improvement in the roller flange of the present invention is a zero slope at the guide surface, which prevents undesirable contact between the roller flange and the tape edge.

If desired, the roller can be machined or fabricated as a single piece. Alternatively, the roller can be machined or fabricated using a multi-piece construction, wherein the flanges are manufactured separately from the body of the roller, and then later assembled together to form the entire finished roller according to the present invention.

A roller 600 for a tape drive system includes a cylindrical center portion 604 for transporting tape, a first flange 602 coupled to a first end of the cylindrical center portion, and a second flange (not shown in FIG. 6) coupled to a second end of the cylindrical center portion 604, wherein the slope of each of the flanges is zero only at a point where the tape contacts the flange 610, and the flange curves gently away from the tape contact point to a flange edge. The flange curve can be a parabolic curve, a relatively large radius on the order of the flange thickness, or an elliptical curve. The roller flange 602 can be made of a ceramic material. The entire roller can also be made of plated aluminum or stainless steel.

The roller flange 602 typically includes a cylindrical outer portion 602A about 0.06 inches thick, and an inner curved portion 402B about 0.06 inches thick. The diameter of the center portion 404 of the roller is about 0.5 to 1.0 inches in diameter. The height of the roller 400 is about 0.8 inches. The outer diameter of the roller flange is about 0.6 to 1.1 inches.

While there have been described above the principles of the present invention in conjunction with specific materials, curve types, and dimensions, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

We claim:

1. A roller for a tape drive system comprising:
a cylindrical center portion for transporting tape;
a first flange coupled to a first end of the cylindrical center portion; and
a second flange coupled to a second end of the cylindrical center portion,
wherein the slope of each of the flanges is zero only at a point where the tape contacts the flange, and the flange curves gently away from the tape contact point to a flange edge.

2. A roller for a tape drive system as in claim 1 wherein the flange curve comprises a parabolic curve.

3. A roller for a tape drive system as in claim 1 wherein the flange curve comprises a relatively large radius on the order of the flange thickness.

4. A roller for a tape drive system as in claim 1 wherein the flange curve comprises an elliptical curve.

5. A roller for a tape drive system as in claim 1 wherein the roller flange comprises a ceramic material.

6. A roller for a tape drive system as in claim 1 wherein the roller comprises plated aluminum or stainless steel.

7. A roller for a tape drive system as in claim 1 wherein the roller flange comprises a cylindrical outer portion about 0.06 inches thick, and an inner curved portion about 0.06 inches thick.

8. A roller for a tape drive system as in claim 1 wherein the diameter of the center portion of the roller is about 0.5 to 1.0 inches.

9. A roller for a tape drive system as in claim 1 wherein the height of the roller is about 0.8 inches.

10. A roller for a tape drive system as in claim 1 wherein the outer diameter of the roller flange is about 0.6 to 1.1 inches.

11. A roller flange for a roller in a tape drive system comprising a flange slope that is zero only at a point where a tape in the tape drive system contacts the flange, and the flange then curves gently away from the tape contact point to a flange edge.

12. A roller flange as in claim 11 wherein the flange curve comprises a parabolic curve.

13. A roller flange as in claim 11 wherein the flange curve comprises a relatively large radius on the order of the flange thickness.

14. A roller flange as in claim 11 wherein the flange curve comprises an elliptical curve.

15. A roller flange as in claim 11 wherein the roller flange comprises a ceramic material.

16. A roller flange as in claim 11 wherein the roller flange comprises plated aluminum or stainless steel.

17. A roller for a tape drive system as in claim 11 wherein the roller flange comprises a cylindrical outer portion about 0.06 inches thick, and an inner curved portion about 0.06 inches thick.

18. A roller for a tape drive system as in claim 11 wherein the outer diameter of the roller flange is about 0.6 to 1.1 inches.

19. A roller for a tape drive system comprising:
a cylindrical center portion for transporting tape;
a first flange coupled to a first end of the cylindrical center portion; and
a second flange coupled to a second end of the cylindrical center portion,
wherein the slope of at least one of the flanges is zero only at a point where the tape contacts the flange, and the flange curves gently away from the tape contact point.

20. A roller as in claim 19 wherein the flange curve comprises a portion of a parabolic curve, a relatively large radius on the order of the flange thickness, or a portion of an elliptical curve.
